(19) United States
(12) Patent Application Publication
(10) Pub. No.: US 2007/0070228 A1
(43) Pub. Date: Mar. 29, 2007

(54) Camera module

(75) Inventor: Chun-Yu Lee, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/416,363

(22) Filed: May 1, 2006

(30) Foreign Application Priority Data
Sep. 26, 2005 (CN) 200510100083.2

(51) Int. Cl. G03B 13/00; H04N 5/335

(52) U.S. Cl. 348/294; 396/97

(57) ABSTRACT

A camera module (8) includes a lens module (10), a focus correction element (20) disposed along optical axis of the lens module (10), an electrical control unit (30), and a temperature sensor (40). The focus correction element includes a transparent flexible sheet (21), a transparent supporting plate (23), and a transparent medium (25) filled between the flexible sheet and the supporting plate. The focus correction element is electrically connected with the electrical control unit, which is also electrically connected with the temperature sensor. The temperature sensor detects a change in ambient temperature, and sends a temperature signal to the electrical control unit. The temperature signal is converted into an electric signal so as to actuate the distortion of the flexible sheet, and cause a change in the curvature of the transparent medium, thus resulting in a change in the focal length of the camera module canceling out a change in the lens module's focal length caused by temperature variation.

### BACKGROUND OF THE INVENTION

1. Field of the Invention

The present invention relates generally to camera modules and, more particularly, to a camera module having a temperature compensation function.

2. Discussion of the Related Art

Recently, with the development of digital camera technologies, people can now enjoy high quality images almost instantaneously. However, problems can be caused by changes in ambient temperature, which may seriously affect the image quality of a camera module in a digital camera, especially in a digital camera including a plastic lens.

As is well known, the shape and refractive index of a lens in a camera module tend to change with temperature variation, thus making the image forming position of a lens unit of such a kind shift forwards at low temperatures and backward at high temperatures, thereby causing a deviation in focus. So the imaging performance of the camera module may be affected by temperature variation.

To solve such problem, a typical camera module usually uses an actuator, such as a step motor, to correct focus deviations in the lens module due to temperature variation. In processing, expansion or contraction of the lens module caused by temperature variation is mechanically detected, and the detected mechanical change is optically converted into an amount of optical displacement by a servo system. Then, a focusing lens is driven by a step motor in such a way as to cancel out the amount of optical displacement. However the camera module using such step motor is relatively large in volume, which may increase difficulty in assembly.

What is needed, therefore, is a camera module having a temperature compensation function, which also has a simple configuration thus facilitating assembling.

### SUMMARY OF THE INVENTION

In one embodiment thereof, a camera module includes a lens module, a focus correction element for compensating the change caused by temperature variation, a temperature sensor, and an electrical control unit. The focus correction element includes a transparent flexible sheet, a transparent supporting plate, and a transparent medium filled between the transparent flexible sheet and the transparent supporting plate. The flexible sheet includes two piezoelectric ceramic slices. The focus correction element is disposed along an optical axis of the lens module, and the focus correction element connects electrically with the electrical control unit, which is also electrically connected with the temperature sensor. The temperature sensor may detect a temperature change in the ambient air and send a temperature signal to the electrical control unit, which converts the temperature signal into an electric signal to actuate a convex or concave distortion of the two piezoelectric ceramic slices, thereby resulting in a change of the camera module's focal length to cancel out a change of the lens module's focal length caused by temperature variation.

Other advantages and novel features will become more apparent from the following detailed description of preferred embodiments when taken in conjunction with the accompanying drawings.

### BRIEF DESCRIPTION OF THE DRAWING

Many aspects of the camera module can be better understood with reference to the following drawing. The components in the drawing are not necessarily drawn to scale, the emphasis instead being placed upon clearly illustrating the principles of the camera module. Moreover, in the drawing, like reference numerals designate corresponding parts throughout the several views.

FIG. 1 is a schematic view of a camera module according to a preferred embodiment of the present invention;

FIG. 2 is a schematic of a partial electrical connection configuration of the camera module of FIG. 1;

FIG. 3 is a schematic view of the camera module at a processing state in FIG. 1; and

FIG. 4 is a schematic view of the camera module at another processing state in FIG 1.

### DETAILED DESCRIPTION OF THE PREFERRED EMBODIMENT

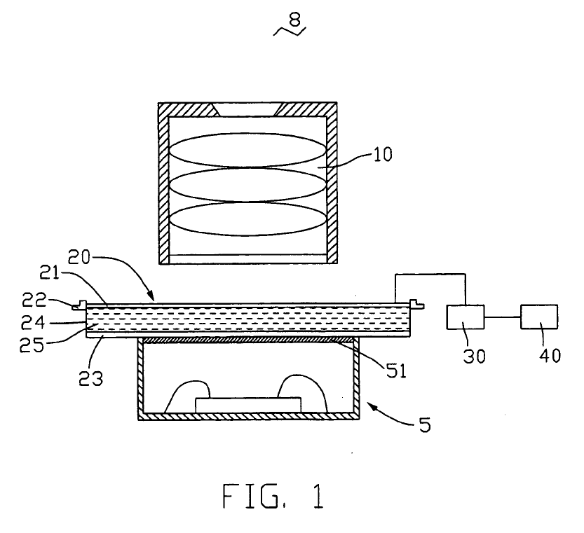

Referring to FIG. 1, in a preferred embodiment, a camera module 8 includes a lens module 10, a focus correction element 20, an electrical control unit 30, a temperature sensor 40, and an image pick-up module 50. The lens module 10, the focus correction element 20, and the image pick-up module 50 are disposed in a linear array along the direction of the optical axis of the lens module 10, and the focus correction element 20 is disposed between the lens module 10 and the image pick-up module 50. The focus correction element 20 connects electrically with the electrical control unit 30, which is also electrically connected with the temperature sensor 40. The image pick-up module 50 has a transparent sealed surface 51.

The focus correction element 20 includes a flexible sheet 21, a holding fixture 22, a supporting plate 23, and a flexible sealed member 24. The flexible sheet 21 and the supporting plate 23 are transparent. The supporting plate 23 lies on the transparent sealed surface 51 of the image pick-up module 50, and the flexible sheet 21 is disposed above the supporting plate 23. The flexible sealed member 24 connects the flexible sheet 21 with the supporting plate 23 thereof. Therefore, a sealed space is defined between the flexible sheet 21 and the supporting plate 23. A transparent medium 25 fills the sealed space. The transparent medium 25 may be a liquid such as water, or an elastomeric material such as clear rubber. The holding fixture 22 is disposed around the edge of the flexible sheet 21, thus supporting the flexible sheet 21.

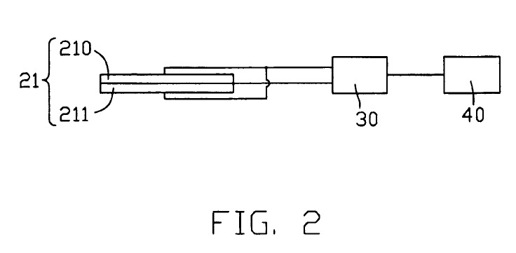

Referring to FIG. 2, the flexible sheet 21 includes a first piezoelectric ceramic slice 210 and a second piezoelectric ceramic slice 211. The first piezoelectric ceramic slice 210 and the second piezoelectric ceramic slice 211 are transparent and superimposed on each other in the direction of polarization. The electrical control unit 30 is a servo system. The first piezoelectric ceramic slice 210 and the second piezoelectric ceramic slice 211 are electrically connected with the electrical control unit 30 in parallel, which is also electrically connected with the temperature sensor 40. The temperature sensor 40 sends a temperature signal to the electrical control unit 30, and the electrical control unit 30 converts the temperature signal into an electric signal, which is subsequently sent to actuate the distortion of the first piezoelectric ceramic slice 210 and the second piezoelectric ceramic slice 211.

It is to be understood that, when the transparent medium 25 is a liquid, its shape could vary in response to the distortion of the flexible sheet 21. When the transparent medium 25 is a flexible solid, it could adhere to the flexible sheet 21 using adhesive. Its shape could also vary in response to the distortion of the flexible sheet 21.

In use, the camera module 8 can be equipped within a portable electronic device, such as a mobile phone.

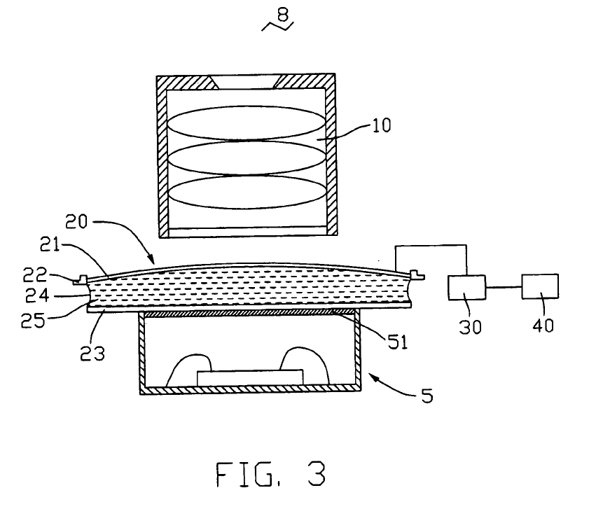

Referring to FIG. 3, when the temperature of the circumstance is lower than a predetermined standard temperature, the focal length of the lens module 10 would become longer than that of the lens module 10 at the standard temperature. In offsetting the shift of the focal length of the lens module 10, the temperature sensor 40 detects a temperature change in the ambient air and sends a temperature signal to the electrical control unit 30, then the electrical control unit 30 converts the temperature signal into an electric signal, which actuates the first piezoelectric ceramic slice 210 to expand radially and actuates the second piezoelectric ceramic slice 211 to contract radially. The expansion of the first piezoelectric ceramic slice 210 and the contraction of the second piezoelectric ceramic slice 211 are restricted by the holding fixture 22, therefore resulting in a slight convex distortion of the first piezoelectric ceramic slice 210 and the second piezoelectric ceramic slice 211. Referring to FIG. 3, the transparent medium 25 is then shaped to the convex distortion of the first piezoelectric ceramic slice 210 and the second piezoelectric ceramic slice 211, which can be regarded as a convex lens and functioned to shorten the focal length of the camera module 8. Thus the convex distortion of the first piezoelectric ceramic slice 210 and the second piezoelectric ceramic slice 211, which is determined by the electric signal, offsets the shift of the focal length of the lens module 10.

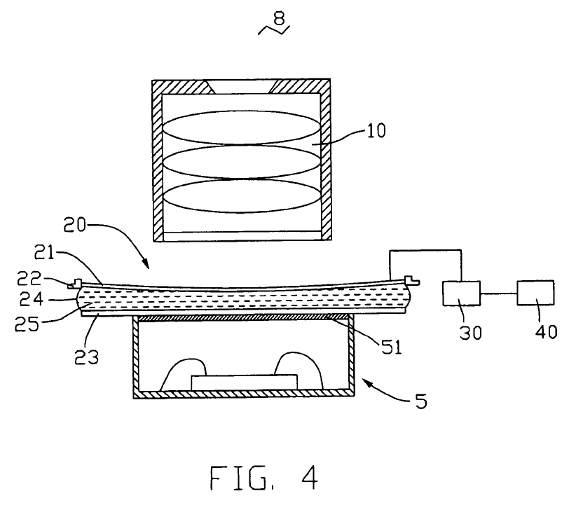

Referring to FIG. 4, when the temperature of the circumstance is higher than the predetermined standard temperature, the focal length of the lens module 10 may become shorter than that of the lens module 10 at standard temperature. In offsetting the shift of the focal length of the lens module 10, the temperature sensor 40 detects a temperature change in the ambient air and sends a temperature signal to the electrical control unit 30, then the electrical control unit 30 converts the temperature signal into an electric signal, which actuates the first piezoelectric ceramic slice 210 to contract radially and actuates the second piezoelectric ceramic slice 211 to expand radially. The contraction of the first piezoelectric ceramic slices 210 and the expansion of the second piezoelectric ceramic slice 211 are restricted by the holding fixture 22, resulting in slight concave distortion of the first piezoelectric ceramic slice 210 and the second piezoelectric ceramic slice 211. Referring to FIG. 4, the transparent medium 25 is then shaped to the concave distortion of the first piezoelectric ceramic slice 210 and the second piezoelectric ceramic slice 211, which can be regarded as a concave lens and functioned to lengthen the focal length of the camera module 8. Thus the concave distortion of the first piezoelectric ceramic slice 210 and the second piezoelectric ceramic slice 211, which is determined by the electric signal, offsets the shift of the focal length of the lens module 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A camera module, comprising:
a lens module;
a focus correction element disposed along the lens module's optical axis, the focus correction element comprising a transparent flexible sheet, a transparent supporting plate, and a transparent medium filled between the flexible sheet and the supporting plate, the flexible sheet including two piezoelectric ceramic slices;
an electrical control unit electrically connecting with the two piezoelectric ceramic slices; and
a temperature sensor electrically connecting with the electrical control unit;
wherein the temperature sensor is configured for detecting a temperature change in the ambient air and sending a temperature signal to the electrical control unit, which is configured for converting the temperature signal into an electric signal to actuate a convex or concave distortion of the two piezoelectric ceramic slices.

2. The camera module as claimed in claim 1, wherein the piezoelectric ceramic slices are superimposed in the direction of polarization.

3. The camera module as claimed in claim 2, wherein the piezoelectric ceramic slices connect electrically with the electrical control unit in parallel.

4. The camera module as claimed in claim 1, wherein the focus correction element has a holding fixture and a flexible sealed member, the holding fixture is disposed around the flexible sheet, for holding the flexible sheet, the flexible sheet and the supporting plate are connected with the flexible sealed member, thereby cooperatively forming a sealed space receiving the transparent medium therein.

5. The camera module as claimed in claim 1, wherein the transparent medium is a liquid.

6. The camera module as claimed in claim 1, wherein the transparent medium is a flexible solid.

7. The camera module as claimed in claim 6, wherein the transparent medium is a clear rubber.

8. A camera module, comprising:
a lens module;
a focus correction element disposed along the lens module's optical axis, comprising a transparent flexible sheet, a transparent supporting plate, and a transparent medium filled between the flexible sheet and the supporting plate;
an electrical control unit electrically connecting with the flexible sheet; and
a temperature sensor electrically connecting with the electrical control unit;
wherein the temperature sensor is configured for detecting a temperature change in the ambient air and sending a temperature signal to the electrical control unit, the electrical control unit is configured for converting the temperature signal into an electric signal to actuate a convex or concave distortion of the flexible sheet.

9. The camera module as claimed in claim 8, wherein the flexible sheet includes two piezoelectric ceramic slices, which are transparent and superimposed.

10. The camera module as claimed in claim 9, wherein the piezoelectric ceramic slices are superimposed in the same direction of the polarization.

11. The camera module as claimed in claim 10, wherein the piezoelectric ceramic slices connect electrically with the electrical control unit in parallel.

12. The camera module as claimed in claim 8, wherein the focus correction element further has a holding fixture and a flexible sealed member, the holding fixture is disposed around the flexible sheet, for holding the flexible sheet, the flexible sheet and the supporting plate are connected with the flexible sealed member, thereby cooperatively forming a sealed space receiving the transparent medium.

13. The camera module as claimed in claim 8, wherein the transparent medium is a liquid.

14. The camera module as claimed in claim 8, wherein the transparent medium is a flexible solid.

15. The camera module as claimed in claim 14, wherein the transparent medium is a clear rubber.

16. A camera module comprising:
a lens module configured for routing light to an image media along an optical axis; and
a focus correction element disposed on the optical axis, the focus correction element configured to be deformable in response to an ambient temperature change so as to effectively form a compensating lens for offsetting a shift of a focal length of the lens module due to said temperature change.

17. The camera module of claim 16, wherein the focus correction element comprises a pair of transparent piezoelectric slices that produces a distortion in response to an electric signal corresponding to said temperature change, and the distortion causes deformation of the focus correction element.

18. The camera module of claim 17, wherein the focus correction element comprises a transparent medium that deforms with the piezoelectric slices.

19. The camera module of claim 16, wherein when the ambient temperature is lower than a predetermined standard temperature, the compensating lens is a convex lens, when the ambient temperature is higher than the predetermined standard temperature, the compensating lens is a concave lens.
